(19) United States
(12) Patent Application Publication
(10) Pub. No.: US 2026/0245175 A1
(43) Pub. Date: Aug. 20, 2026

(54) SYSTEM AND METHOD FOR UNDERBODY IMAGE CAPTURE AND GENERATION

(71) Applicant: OPENLANE, Inc., Carmel, IN (US)

(72) Inventor: Daniel Neugent, Stilwell, KS (US)

(73) Assignee: OPENLANE, Inc., Carmel, IN (US)

(21) Appl. No.: 19/054,484

(22) Filed: Feb. 14, 2025

(51) Int. Cl. G06T 3/608; G06V 20/50; H04N 23/63

(52) U.S. Cl. CPC G06T 3/608; G06V 20/50; H04N 23/63

(57) ABSTRACT

System and Method for generating a concatenated image of a vehicle underbody. Vehicle underbodies may be subject to one or more problems, such as rust, exhaust system modification or lack of a catalytic converter. In order to inspect a vehicle, an image of the vehicle underbody may be generated. To generate the image, a mobile device, such as a smartphone, may be placed proximate to but not in fixed relation to a mirror, which is pointed upward toward the vehicle underbody. The mobile device may take a video of the underbody as the vehicle is driven over the mirror and mobile device. After which, frames of the video may be concatenated together and analyzed for the problems in order to present to the inspector.

### FIELD OF THE INVENTION

The present application relates generally to inspection of a vehicle, and more specifically to capturing and generating an image of an underbody of a vehicle.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Various parts of a vehicle may be inspected. One part of the vehicle subject to inspection is the underbody. In particular, the vehicle underbody may be inspected for rust or corrosion, which may be due to exposure to various environmental elements, such as salt, dirt, moisture, etc.. Moreover, the vehicle underbody may be inspected to ensure that certain parts, such as the catalytic converter, are present. Finally, the vehicle underbody may be inspected to determine whether certain systems, such as the exhaust system, have been modified.

As part of the vehicle underbody inspect process, an image of the vehicle body may be generated. However, generating a vehicle underbody image (interchangeably termed an underbody image or an undercarriage image) may be difficult due to the potentially low clearance of the vehicle from the ground.

### SUMMARY

In one or some embodiments, a method for generating at least one concatenated image of a vehicle underbody is disclosed. The method comprises: generating, using at least one mobile device, a plurality of images of the vehicle underbody; generating, using at least a part of the plurality of images, the at least one concatenated image independent of any analysis amongst the plurality of images; after generating the at least one concatenated image, performing at least one post-processing action on the concatenated image to generate at least one post-processed concatenated image; and outputting the at least one post-processed concatenated image.

In one or some embodiments, at least one mobile device configured for inspection of a vehicle underbody is disclosed. The at least one mobile device comprises: at least one camera configured to generate a plurality of images of the vehicle underbody; at least one input device; at least one output device; and at least one processor in communication with the at least one camera, the at least input device, and the at least one output device. The at least one processor configured to: access at least one post-processed concatenated image that was generated by: generating at least one concatenated image using at least a part of the plurality of images of the vehicle underbody and generated independently of any analysis amongst the plurality of images; and post-processing the at least one concatenated image of the vehicle underbody; output, on the at least one output device for an inspector, the at least one post-processed concatenated image of the vehicle underbody; and receive, from the inspector via the at least one input device, input regarding the at least one post-processed concatenated image of the vehicle underbody.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 illustrates an exemplary inspection system, which may include an application server and one or more mobile electronic devices.

FIG. 2 illustrates a block diagram of exemplary computer architecture for a device in the exemplary communication system of FIG. 1.

FIG. 3A illustrates an exemplary flow diagram of logic to capture and generate an underbody image for use in an inspection report.

FIGS. 3B-D illustrate different examples of de-skewing.

FIG. 4 illustrates an exemplary flow diagram of logic to generate concatenated image(s).

FIGS. 5A-B illustrates example concatenated images.

FIG. 6 illustrates an example of a post-processed concatenated image, in which one or more post-processing actions are performed on the concatenated image.

FIG. 7 is an example of a structure on which to place the mobile device and the mirror.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, the underbody of a vehicle may be subject to inspection, such as part of an overall inspection of the vehicle. Various types of vehicles are contemplated (e.g., cars, trucks, boats, etc.). When inspecting the underbody, the inspector may obtain an image of part or all of the underbody of the vehicle. However, this may be difficult, particularly given the limited clearance of vehicles from the ground.

Thus, in one or some embodiments, a system and method for capturing and generating an underbody image is disclosed. In one or some embodiments, any one, any combination, or all of the following may be performed: placing one or more components on the ground (e.g., mirror and/or image capture device); activating the image capture device (e.g., a mobile image capture device) to obtain images (e.g., activate video recording by physically touching a part of the mobile image capture device or by wirelessly sending a command to the mobile image capture device to activate the video recording); drive the vehicle subject to underbody inspection partly or entirely over the one or more components; after driving, control the image capture device to stop obtaining images (e.g., deactivate video recording); generate concatenated image(s) from the obtained images; performing one or more post-processing actions on the concatenated image(s); outputting the post-processed concatenated image(s) for the inspector to review; receiving input from the inspector regarding one or more aspects of the output (e.g., the inspector selecting a best image of the underbody; the inspector agreeing or disagreeing with the analysis of the identifying feature(s) of the underbody, discussed further below); and generating an inspection report based on one or both of the post-processed concatenated image(s) or the input from the inspector.

In practice, the inspector may place the components on the ground without being in fixed relation to one another. By way of example, the inspector may place the smartphone and the mirror on the ground more in a free-form manner and without a mechanical structure therebetween (forcing the fixed relation). In this regard, at least two devices, such as at least one image capture device (e.g., a smartphone with camera functionality or a digital camera) and at least one mirror (e.g., a long rectangular mirror), which may be used in order to capture images (e.g., video) of the underneath or underbody of a vehicle. In one or some embodiments, the at least two devices may be freestanding, such as not being in fixed relation to one another. For example, the at least two devices may not have any structure mechanically connecting each other. Thus, the free standing device(s) may be used for the image capture, with the free standing devices being such that the image capture device has in its view at least part of (or the entire) length and/or width of the mirror. By way of example, the image capture device need not be straight or aligned with the mirror. Rather, even if the position of the image capture device is skewed or misaligned with the mirror, one or more post-processing actions (discussed further below) may be performed to at least partly compensate (or entirely compensate) for the skew or misalignment (e.g. post-processing may access the reflection of the vehicle from a respective video frame). Thus, to the extent that there may be a skew or misalignment between the smartphone and the mirror (which might be manifested in the video or images taken by the smartphone), post-processing of the concatenated image(s) may reduce or eliminate such errors.

After obtaining the images (either in the form of still images or a video), one or more concatenated images may be generated. In one or some embodiments, a respective concatenated image is generated from at least two underlying images and is independent of any predicate analysis the at least two underlying images used to generate the concatenated image. Concatenation may thus comprise linking or joining the underlying images together. By way of example, the respective concatenated image may be composed of at least two underlying images, at least three underlying images, at least four underlying images, at least five underlying images, etc. In one or some embodiments, the selection of the underlying images is performed independent of, and not based on the substance or any analysis of, the underlying frames (e.g., not based on the values of the pixels in the underlying images). Rather, the selection of the underlying images may be set or predetermined. One particular assumption may be that the vehicle is driven over the smartphone at a constant speed as the smartphone is generating the video of the underbody. Given this particular assumption, the system may then select the X number of underlying images based on a predetermined frame rate of the video (e.g., select every sixth frame; select every seventh frame; select every eight frame). Thus, the system (whether on the smartphone and/or on the server) may select every predetermined frame (e.g., every seventh frame and/or every eight frame) as the underlying images for subsequent concatenation as part of the concatenated image.

In one or some embodiments, a single concatenated image is generated from a single pass of the vehicle over the mobile image capture device. Alternatively, multiple concatenated images are generated from the single pass of the vehicle over the mobile image capture device. As discussed above, the selection of the underlying images used to generate the concatenated image may be based on the selection of every Nth frame in a video of the single pass of the vehicle over the mobile image capture device. Thus, in one example, three separate concatenated images may be generated, with a first concatenated image being generated from underlying images selected as every sixth frame of the video, a second concatenated image being generated from underlying images selected as every seventh frame of the video, and a third concatenated image being generated from underlying images selected as every eighth frame of the video. As discussed in more detail below, each of the concatenated images generated may be: (i) subject to pre-processing action(s); (ii) output to the inspection for review and potential selection; and (iii) inclusion in an inspection report. Thus, once the video has been captured, the software on the smartphone may then create multiple concatenated images by taking frames of the video at specific positions, anticipating that the driver of the vehicle drives at a specific speed as s/he drives the vehicle over the phone or camera and mirror.

Various post-processing actions are contemplated, including any one, any combination, or all of: removing portion(s) of the concatenated image(s); modifying (e.g., smoothing, editing, adding, superimposing upon) portion(s) of the concatenated image(s); or analyzing portion(s) of the concatenated image(s);

As one example, one of the post-processing actions may comprise analysis to identify feature(s) of the underbody (e.g., any one, any combination, or all of: rust; components of the underbody present; components of the underbody missing; components of the underbody modified; etc.). In particular, with regard to identifying rust, the system may access pixel values, such as having R/G/B colors similar to a spectrum of colors identified using training images that indicate rust. Based on these pixel values, the system may scan the concatenated images for values of pixels that are similar (indicating pixels that show rust). Responsive to the system identifying the same or similar pixel values, the system may modify the image in one or more ways in order to highlight potential rust within this underbody scan. As one example, the system may place an overlay (e.g., a box) over the section of the image identified as potential rust. Alternatively, or in addition, the system may modify the image (such as changing pixel values to a highlighted color, such as bright yellow) to highlight the potential rust. The modified concatenated image may then be shown to the inspector to review and to confirm the rust before adding this to the condition report shown to potential buyers and the seller of the vehicle in the wholesale marketplace (e.g., the inspector may input whether s/he agrees or disagrees that the highlighted area is rust).

In one or some embodiments, the server, accessing a machine-learned (ML) model, may perform the post-processing action of identifying feature(s) of the underbody using the ML model. In particular, a database of quality underbody pictures may be used in order to construct machine learning models that may be built to better identify desirable or undesirable traits in the underbody of cars. Alternatively, or in addition, this database may also be used to better determine the worth of vehicles.

As another example, the post-processing action may comprise removing and/or modifying portion(s) of the concatenated image that are external to the vehicle underbody. In one or some embodiments, the system may: determine the external boundary of the vehicle underbody in the concatenated image(s), thereby defining a plurality of pixels that are external to the vehicle underbody; and remove and/or modify portion(s) from the concatenated image or modifying pixel values of at least some of the plurality of pixels in the concatenated image (e.g., delete the pixels that are outside of the boundary and/or change the values of the pixels to black or white for those pixels that are outside of the boundary). For example, the system may analyze a respective concatenated image to determine the external boundary of the vehicle underbody within the concatenated image by analyzing one or more portions of the concatenated image. In one or some embodiments, the respective concatenated image may have a first portion being the image of the underbody and a second portion being the background. In this regard, identifying one or both of the first portion of the image (e.g., the image of the underbody) or the second portion of the image (e.g., the background) may be performed in one or more ways.

In one way, the system may review predetermined value(s) (e.g., a single pixel value, multiple pixel values, and/or a range of pixel values) for pixel in the concatenated image. Responsive to the system identifying in the concatenated image pixel values that match the predetermine value(s), the system may remove and/or modify those pixels as background. In one or some embodiments, the mirror may have, along one or more sides of its periphery, a predetermined color. As one example, the predetermined color may comprise predetermined R, G, B values (e.g., a single R value, a single G value, a single B value; or a range R of values, a range G of values, a range B of values). In one or some embodiments, the predetermined color may be programmed into the mobile device. Alternatively, or in addition, a user may input the predetermined color into the mobile device (e.g., by commanding the mobile device to take an image of the predetermined color). In either case, the mobile device may access the predetermined value(s) in order to compare with the pixel values in the concatenated image (in order to identify the background and remove/revise the concatenated image accordingly).

In another way, the system may: (i) search for specific indicia in the concatenated image (e.g., specific contours and/or shapes, such as rectangular or trapezoidal shape of similar pixels); (ii) label the identified indicia (e.g., label the identified shape as the perimeter of the mirror); and (iii) modify the concatenated image (e.g., crop anything outside of the identified shape). In either case, the system need only identify pixel values of interest without the need to perform any type of motion detection (e.g., independent of any analysis amongst the plurality of images and/or independent of any analysis within a respective image of the plurality of images) or identifying changes in pixel values.

As still another example, the post-processing action may comprise smoothing one or more portions of a respective concatenated image. In particular, the respective concatenated may be generated by combining at least a first image with a second image so that the concatenated image, when displayed, includes pixels from the first image and pixels from the second image that abut one another. Smoothing (e.g., averaging) may be performed for the values of the pixels from the first image and the pixels from the second image that abut one another. In this way, the post-processing may modify the respective concatenated image.

Thus, in one or some embodiments, the software (which may be executed on the smartphone) may select frames by doing math-based on a frames-per-second calculation and then blend the seams of the frames together (e.g., smoothing) in order to concatenate these frames into a single image. The software may then generate multiple concatenated images (e.g., three images based on three different frames-per-second) and then present these multiple concatenated images back to the inspector for review to choose the best option.

As discussed above, various electronic device(s) may be used to perform the functions described herein. For example, in one or some embodiments, one or more actions related to the inspection may be performed using a mobile computer (e.g., smartphone, portable tablet, etc.). In particular, the mobile computer may obtain the images and perform the image processing or other post-processing actions, thereby ensuring inspectors in more remote locations with less access to Wi-Fi or other wireless communication services may still be able to properly and efficiently complete the inspection. After image processing and other tasks are completed, the mobile computer may transmit final post-processed concatenated image to the backend servers for further use (e.g., generation of inspection reports). Alternatively, or in addition, the inspection may be performed using a server (e.g., a remote or a backend server). Thus, in one or some embodiments, one or both of the following may be performed locally (e.g., using the mobile computer): generating the concatenated image(s); or performing one or more post-processing actions. For example, the mobile image capture device, such as the smartphone, which may be proximate to the vehicle subject to inspection, may generate the concatenated image(s) and/or may perform one or more of the post-processing actions. Alternatively, or in addition, one or both of the following may be performed remotely (e.g., at the remote server): generating the concatenated image(s); or performing one or more post-processing actions.

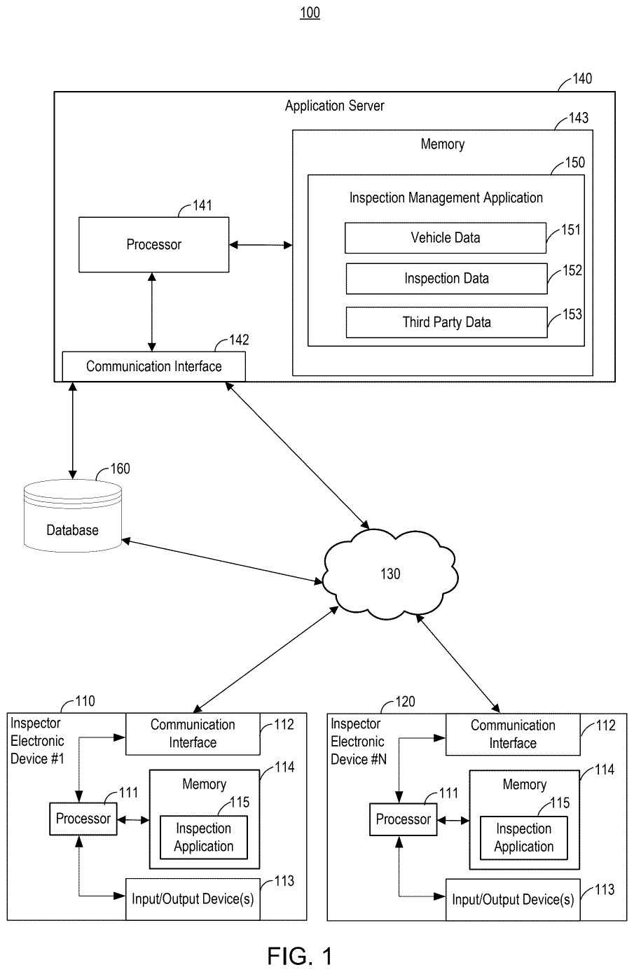

Referring to the figures, FIG. 1 illustrates an exemplary inspection system 100 (the “system”) that includes component devices for implementing the described features. The system 100 includes an application server 140 configured to include the hardware, software, firmware, and/or middleware for operating an inspection management application 150. Application server 140 is shown to include a processor 141, a memory 143, and a communication interface 142. The inspection management application 150 is described in terms of functionality to manage inspection of one or more vehicles.

Inspection management application 150 may be a representation of software, hardware, firmware, and/or middleware configured to implement the management of any one, any combination, or all of the stages of inspection. In one implementation, the Inspection management application 150 may be a web-based application operating, for example, according to a . NET framework within the system 100. More specifically, the inspection management application 150 may include vehicle data 151, inspection data 152, and third party data 153. By way of example, data stored and accessible by the inspection management application 150 may comprise data generated from previous inspections, ML models, or the like.

The system 100 may further include a database 160 for storing data for use by the inspection management application 150. The application server 140 may communicate with the database 160 directly to access the data. Alternatively, the application server 140 may communicate with the database 160 via network 130 (e.g., the Internet). Though FIG. 1 illustrates direct and indirect communication, in one implementation, only direct communication is used, in an alternate implementation, only indirect communication is used, and still in an alternate implementation, both direct and indirect communication is used.

The application server 140 may communicate with any number and type of communication devices via network 130. For example, application server 140 may communicate with electronic devices associated with inspectors. For example, FIG. 1 depicts inspector electronic device #1 110 and inspector electronic device #N 120. One or more inspector electronic devices are contemplated, such as N such devices show in FIG. 1. The depiction in FIG. 1 is merely for illustration purposes.

Inspector electronic device #1 110 and inspector electronic device #N 120 shown in FIG. 1 may include well known computing systems, environments, and/or configurations that may be suitable for implementing features of the inspection management application 150 such as, but are not limited to, smartphones, tablet computers, personal computers (PCs), server computers, handheld or laptop devices, multiprocessor systems, microprocessor-based systems, network PCs, server computers, minicomputers, mainframe computers, embedded systems, distributed computing environments that include any of the above systems or devices, and the like. FIG. 1 further shows that the shipper electronic device 110 includes a processor 111, a memory 114 configured to store the instructions for operating inspection application 115 (inspection application 115 may be a part of the inspection management application 150 in that the inspection application 115 communicates with the inspection management application 150), an input/output device(s) 113 (which may comprise separate input and output devices, or a combined input and output device, such as a touchscreen), and a communication interface 112. A shipper operating the shipper electronic device 110 may run the inspection application 115 to access the inspection management application 150 running on the application server 140.

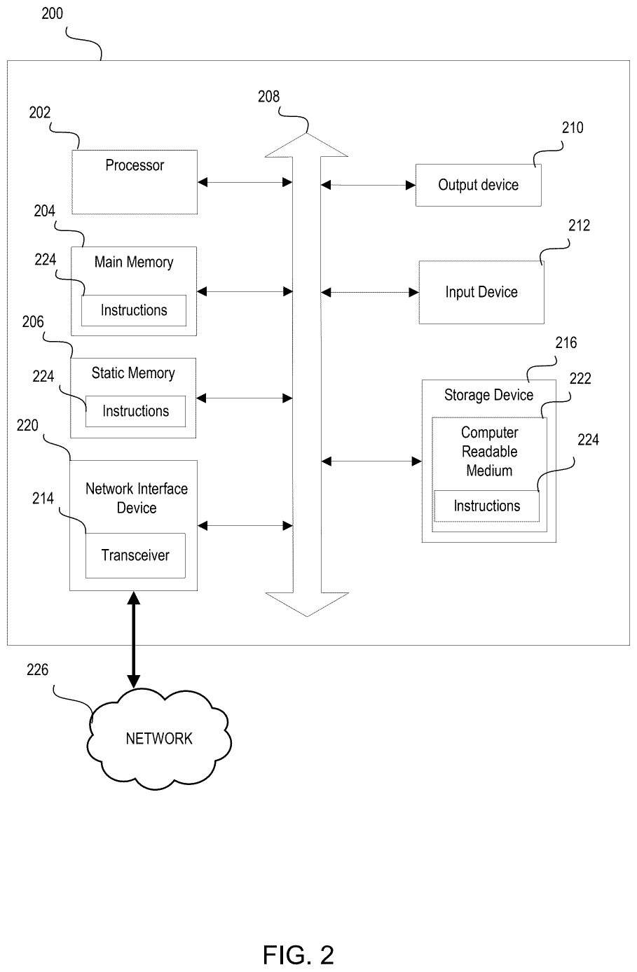

The various electronic devices depicted in FIG. 1 may be used in order to implement the functionality discussed herein. In this regard, each of inspection electronic device #1 110, inspection electronic device #N 120, application server 140, and database 160 may include one or more components of computer system 200 illustrated in FIG. 2.

FIG. 2 illustrates exemplary computer architecture for computer system 200. Computer system 200 includes a network interface 220 that allows communication with other computers via a network 226, where network 226 may be represented by network 130 in FIG. 1. Network 226 may be any suitable network and may support any appropriate protocol suitable for communication to computer system 200. In an implementation, network 226 may support wireless communications. In another implementation, network 226 may support hard-wired communications, such as a telephone line or cable. In another implementation, network 226 may support the Ethernet IEEE (Institute of Electrical and Electronics Engineers) 802.3x specification. In another implementation, network 226 may be the Internet and may support IP (Internet Protocol). In another implementation, network 226 may be a LAN or a WAN. In another implementation, network 226 may be a hotspot service provider network. In another implementation, network 226 may be an intranet. In another implementation, network 226 may be a GPRS (General Packet Radio Service) network. In another implementation, network 226 may be any appropriate cellular data network or cell-based radio network technology. In another implementation, network 226 may be an IEEE 802.11 wireless network. In still another implementation, network 226 may be any suitable network or combination of networks. Although one network 226 is shown in FIG. 2, network 226 may be representative of any number of networks (of the same or different types) that may be utilized.

The computer system 200 may also include a processor 202, a main memory 204, a static memory 206, an output device 210 (e.g., a display or speaker), an input device 212, and a storage device 216, communicating via a bus 208.

Processor 202 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 202 executes instructions 224 stored on one or more of the main memory 204, static memory 206, or storage device 215. Processor 202 may also include portions of the computer system 200 that control the operation of the entire computer system 200. Processor 202 may also represent a controller that organizes data and program storage in memory and transfers data and other information between the various parts of the computer system 200.

Processor 202 is configured to receive input data and/or user commands through input device 212. Input device 212 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computer system 200 and control operation of computer system 200 and/or operation of the inspection management application 150. Input device 212 as illustrated in FIG. 2 may be representative of any number and type of input devices.

Processor 202 may also communicate with other computer systems via network 226 to receive instructions 224, where processor 202 may control the storage of such instructions 224 into any one or more of the main memory 204 (e.g., random access memory (RAM)), static memory 206 (e.g., read only memory (ROM)), or the storage device 216. Processor 202 may then read and execute instructions 224 from any one or more of the main memory 204, static memory 206, or storage device 216. The instructions 224 may also be stored onto any one or more of the main memory 204, static memory 206, or storage device 216 through other sources. The instructions 224 may correspond to, for example, instructions that make up the data retention strategy and the inspection management application 150 or inspection application 115 illustrated in FIG. 1.

Although computer system 200 is represented in FIG. 2 as a single processor 202 and a single bus 208, the disclosed implementations applies equally to computer systems that may have multiple processors and to computer systems that may have multiple busses with some or all performing different functions in different ways.

Storage device 216 represents one or more mechanisms for storing data. For example, storage device 216 may include a computer readable medium 222 such as read-only memory (ROM), RAM, non-volatile storage media, optical storage media, flash memory devices, and/or other machine-readable media. In other implementations, any appropriate type of storage device may be used. Although only one storage device 216 is shown, multiple storage devices and multiple types of storage devices may be present. Further, although computer system 200 is drawn to contain the storage device 216, it may be distributed across other computer systems that are in communication with computer system 200, such as a server in communication with computer system 200. For example, when computer system 200 is representative of inspection electronic device #1 110 or inspection electronic device #N 120, storage device 216 may be distributed across to application server 140 when inspection electronic device #1 110 and/or inspection electronic device #N 120 is in communication with application server 140 during operation of the inspection management application 150 and/or inspection application 115.

Storage device 216 may include a controller (not shown) and a computer readable medium 222 having instructions 224 capable of being executed by processor 202 to carry out functions of the inspection management application 150 and/or inspection application 115. In another implementation, some or all of the functions are carried out via hardware in lieu of a processor-based system. In one implementation, the controller included in storage device 216 is a web application browser, but in other implementations the controller may be a database system, a file system, an electronic mail system, a media manager, an image manager, or may include any other functions capable of accessing data items. Storage device 216 may also contain additional software and data (not shown), for implementing described features.

Output device 210 is configured to present information to the user. For example, output device 210 may be a display such as a liquid crystal display (LCD), a gas or plasma-based flat-panel display, or a traditional cathode-ray tube (CRT) display or other well-known type of display in the art of computer hardware. Accordingly, in some implementations, output device 210 displays a user interface. In other implementations, output device 210 may be a speaker configured to output audible information to the user. In still other implementations, any combination of output devices may be represented by the output device 210.

Network interface 220 provides the computer system 200 with connectivity to the network 226 through any compatible communications protocol. Network interface 220 sends and/or receives data from the network 226 via a wireless or wired transceiver 214. Transceiver 214 may be a cellular frequency, radio frequency (RF), infrared (IR) or any of a number of known wireless or wired transmission systems capable of communicating with network 226 or other computer device having some or all of the features of computer system 200. Bus 208 may represent one or more busses, e.g., USB, PCI, ISA (Industry Standard Architecture), X-Bus, EISA (Extended Industry Standard Architecture), or any other appropriate bus and/or bridge (also called a bus controller). Network interface 220 as illustrated in FIG. 2 may be representative of a single network interface card configured to communicate with one or more different data sources.

Computer system 200 may be implemented using any suitable hardware and/or software, such as a personal computer or other electronic computing device. In addition, computer system 200 may also be a portable computer, laptop, tablet or notebook computer, PDA, pocket computer, appliance, telephone, server computer device, or mainframe computer.

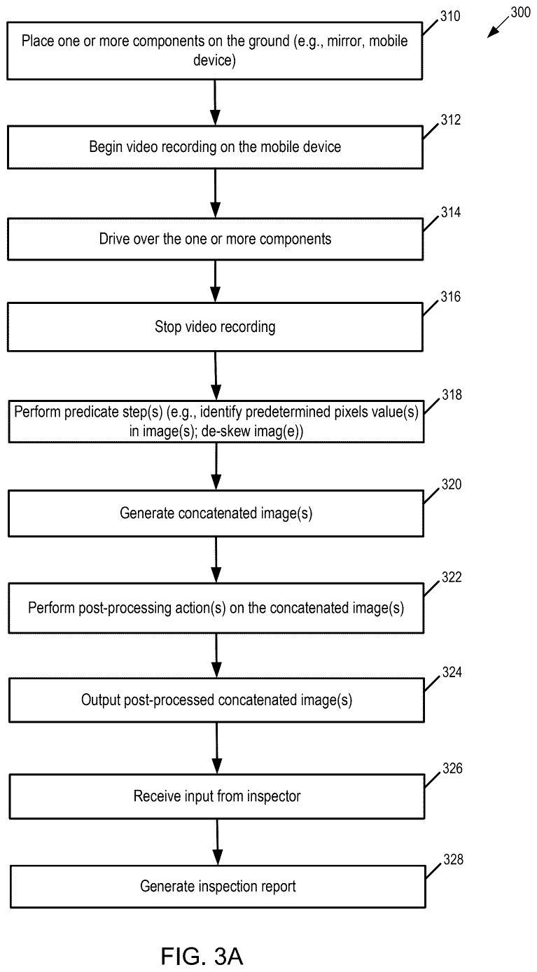

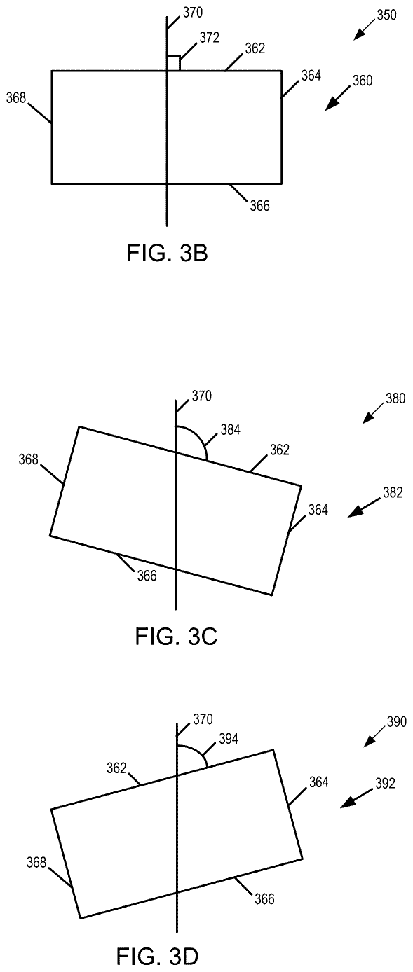

FIG. 3A illustrates an exemplary flow diagram 300 of logic to capture and generate an underbody image for use in an inspection report. At 310, the inspector places one or more components on the ground. For example, one or both of a mirror or a mobile device (e.g., the smartphone) may be placed on the ground. At 312, the inspector may begin video recording on the mobile device. There are various ways in which the inspector may activate the video recording on the mobile device. In one way, the inspector may physically touch the mobile device in order for the mobile device to start video recording. In another way, the inspector may transmit a command wirelessly (e.g., via Bluetooth® or other short-range wireless communication protocol) that the mobile devices receives, and responsive to receipt, start video recording. At 314, the inspector (or another person) may drive the vehicle over the one or more components. At 316, the inspector may stop recording video. Again, there are various ways in which the inspector may stop the video recording on the mobile device, including by physically touching the mobile device or by wirelessly transmitting a command.

At 318, one or more predicate steps may be performed on one or more frames in the video recording obtained, such as one or both of: identifying pixels of predetermined value(s); or de-skewing image(s). In one or some embodiments, the one or more predicate steps may be performed on each frame in the recorded video. Alternatively, the one or more predicate steps may be performed on less than all of the frames in the recorded video. For example, in one or some embodiments (discussed further below at 320), concatenated image(s) may be generated based on one or more pre-determined frame rates (e.g., every sixth frame of the video, every seventh frame of the video, etc.). In such an example, the one or more predicate steps may be performed only on the frames according to the pre-determined frame rates (e.g., for every sixth frame of video used to concatenate, the one or more predicate steps are then performed on every sixth frame).

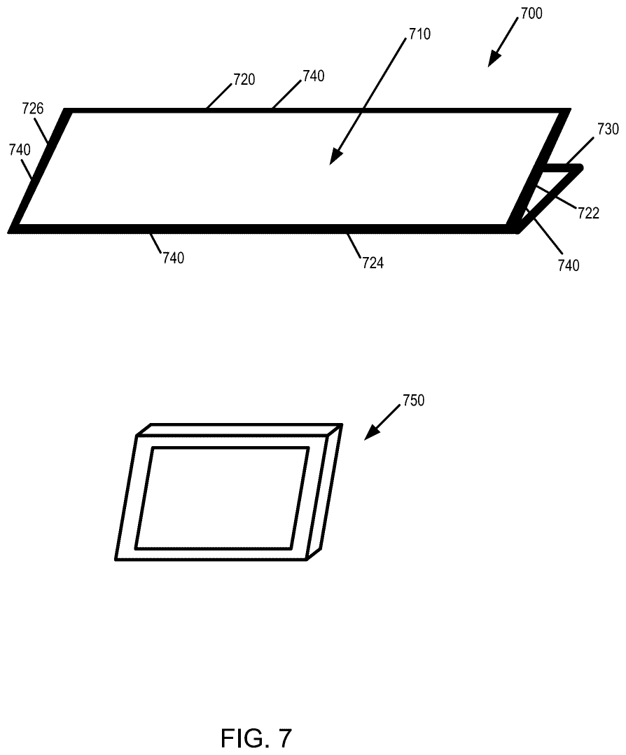

Referring back to the one or more predicate steps, pixels of predetermined value(s) (or within a range of predetermined value(s)) may be identified in one or more of the video frames of the recorded video (e.g., whether in all frames of the recorded video or in a subset of the frames in the recorded video). Specifically, as discussed below with regard to FIG. 7, the mirror may include a mirror frame (such as frame 740), which frames or outlines the mirror and which may comprise a predetermined color (e.g., predetermined values (or predetermined ranges of values) of Red (R), Green (G), Blue (B); predetermined values (or predetermined ranges of values) of Hue (H), Saturation (S), Value (V); etc.). Further, the video may include, within the video frames, images of the mirror and the mirror frame. Thus, in one or some embodiments, prior to generating the concatenated image(s), one or more steps may be performed. One step may comprise removing pixels that include the mirror frame (and outward from the mirror frame) from a respective video frame. To do this, the pixels of the predetermined value(s) may be identified. In this regard, no motion detection (which may comprise analysis of pixels within a respective video frame and/or analysis of pixels across different video frames) needs to be performed, such as no need for analysis to identify changing pixels.

The predetermined value(s) (or range of predetermined value(s)) may be determined in one of several ways. In one way, the predetermined value(s) (or range of predetermined value(s)) may be stored in a memory of the mobile device that records the video, and thereafter generates the concatenated image. By way of example, an app (e.g., a computer application) may be downloaded to the mobile device. Stored within the app may be the predetermined value(s) (or range of predetermined value(s)) so that upon execution of the app, the app may access the predetermined value(s) (or range of predetermined value(s)) in order for the app to remove the pixels with the predetermined value(s) (or range of predetermined value(s)) (and outward). In one or some embodiments, the predetermined value(s) (or range of predetermined value(s)) may be pre-loaded within the app upon download from the app store. Alternatively, or in addition, the predetermined value(s) (or range of predetermined value(s)) may be transmitted from a central server for storage after the app has been downloaded from the app store.

Alternatively, or in addition, the predetermined value(s) (or range of predetermined value(s)) may be based on a user definition. As one example, the user may, using the mobile device that has the app downloaded therein (and as part of configuring the app), take an image of the mirror frame and may, via a touchscreen on the mobile device (which is an example of an input device and an output device in combination), input an indication of the mirror frame to the app (e.g., the user may touch the portion of the image on the touchscreen to indicate to the app the portion of the image where the mirror frame is present). In this way, the app may identify within the image the pixels (and the associated pixel value(s)) that correspond to the mirror frame. Based on this user input, the app may identify the predetermined value(s) as being the value(s) of the pixel(s) that the user touched within the image on the touchscreen (and store these pixel value(s) for later use by the app). Alternatively, or in addition, the range(s) of predetermined value(s) may be determined by: (i) first identifying the predetermined value(s) of the pixel(s) that the user touched within the image on the touchscreen; and (ii) defining the range(s) of the predetermined value(s) as being a predetermined defined pixel range that is centered around the identified predetermined value(s). In either instance, the user may provide the user definition once (e.g., during initial configuration of the app), with the predetermined value(s) (or range of predetermined value(s)) based on the user definition later being accessed by the app when the app is later executed.

As another example, the user may, using the mobile device that has the app downloaded therein (and after the mobile device generates the video but prior to the mobile device generating the concatenated image), input the indication of the mirror frame to the app (e.g., the user may touch the portion of the image on the touchscreen to indicate to the app the portion of the image where the mirror frame is present). Thus, after 316 (where the video recording is stopped), but prior to 320 (where the concatenated image(s) is/are generated), one or more images from the video just recorded may be output on the touchscreen. The user may then touch a part of the screen where the mirror frame is present, indicating to the app the mirror frame in the image. Thus, the user may provide input (e.g., touching the screen) to simultaneously serve one or more of the following purposes: (i) an indication by the user for purposes of defining the mirror frame; or (ii) an indication to proceed with generating the concatenated image.

Alternatively, or in addition to identifying the predetermined pixel value(s) (or a range of predetermined value(s)), de-skewing may be performed. In particular, because the mirror and the mobile device are not in fixed relation to one another, the mobile device may not be aligned with the mirror so that the images generated by the mobile device may likewise not be aligned. In this regard, the video generated by the mobile device may be skewed, such as tilted or rotated, relative to the mirror. As such, prior to concatenating the images, the images may be de-skewed so that the images are effectively aligned with the mirror. In one or some embodiments, after determining the mirror frame (and removing the mirror frame (and outward) from a respective video frame), the image from the respective video frame may be analyzed to determine whether the image is skewed. In other words, when the mirror and the mobile device are in perfect alignment, the mirror frame (as shown in the respective video frame) is a perfect rectangle, with two sides being vertical and two sides being horizontal. This is shown in illustration 350 in FIG. 3B in which the image 360 (having 4 sides 362, 364, 366, 368) has a vertical line 370 superimposed thereon. In this regard, superimposing vertical line 370 onto the image (generated from a respective video frame by removing the mirror frame and outward, and resulting in the perfect rectangle, with two vertical and two horizontal lines) will form a 90° angle (shown as angle 372) with the sides 362 or 366.

However, when the mirror and the mobile device are not in perfect alignment, the mirror frame (as shown in the respective video frame) has lines that are not a perfect rectangle. Rather, a vertical line, superimposed on the image (generated by removing the mirror frame and outward), forms an angle that is either greater than 90° or less than 90° with two of the lines (e.g., that are supposed to be horizontal). As such, the angle formed (whether greater than 90° or less than 90°) indicates the amount of skew. As one example shown in the illustration 380 in FIG. 3C in which the image 382 has a vertical line 370 superimposed thereon, an angle 384 formed that is greater than 90° indicates that the image is skewed clockwise. As another example shown in the illustration 390 in FIG. 3D in which the image 392 has a vertical line 370 superimposed thereon, an angle 394 formed that is less than 90° indicates that the image is skewed counterclockwise.

Thus, in one or some embodiments, the angle (such as angle 384 or angle 394) indicates the amount of rotation to de-skew the image. In this regard, responsive to determining that the superimposed vertical line 370 results in a non-90° angle, the determined angle will be used to determine how much to rotate the image (e.g., in FIG. 3B, rotate image 382 counterclockwise by (angle 384)—90°; in FIG. 3C, rotate image 392 clockwise by 90° (angle 394)).

At 320, one or more concatenated image(s) may be generated (e.g., generated locally on the mobile device that generated the video recording and/or on a backend server). As discussed above, the concatenated image(s) may be generated without image analysis of the underlying images (such as detecting motion identifying changing pixels). Rather, selection of the underlying images, used to generate the concatenated image(s), may be pre-determined, such as based on one or more pre-determined frame rates (e.g., every sixth frame of the video, every seventh frame of the video, etc.) and/or predetermined pixel value(s). As noted above, after selecting the underlying images, one or more predicate steps may be performed, such as removing pixels and/or de-skewing. After which, the images may be used to generate the concatenated image(s).

After which, at 322, one or more post-processing action(s) on the concatenated image(s) may be performed. As discussed above, post-processing action(s) may comprise any one, any combination, or all of: analyzing the concatenated image(s) (e.g., analysis to determine one or more of: whether rust is present; whether components of the underbody present; whether components of the underbody missing; whether components of the underbody modified; etc.); adding to the concatenated image(s) (e.g., superimposing a box or other overlay onto the concatenated image(s) in order to highlight rust); or modifying the concatenated image(s) (e.g., smoothing the concatenated image(s); changing the concatenated image(s) to highlight rust; changing the concatenated image(s) to distinguish the background)).

At 324, the post-processed concatenated image(s) are output for the inspector to review. In one or some embodiments, a single post-processed concatenated image is output (e.g., on the smartphone of the inspector) for review by the inspector and potentially to solicit input from the inspector. Alternatively, multiple post-processed concatenated images are output. As discussed above, multiple concatenated images may be generated and post-processed so that multiple post-processed concatenated images may be output to the inspector for review and potentially to solicit input from the inspector.

At 326, the system may receive the input from inspector. The inspector may provide various types of input. As one example, the inspector may approve the post-processed concatenated image(s) that were output. In one particular example (where a single post-processed concatenated image is output), the inspector may indicate whether the single post-processed concatenated image output is acceptable. If so, the single post-processed concatenated image may be included in the inspection report. If not, the system may restart the process to generate another concatenated image (e.g., generate a new concatenated image based on a different frame rate). In another particular example (where multiple post-processed concatenated images are output), the inspector may indicate which, of the multiple post-processed concatenated images output, are the best for purposes of inclusion in the inspection report. Alternatively, or in addition, the output may solicit input as to any one, any combination, or all of: whether rust is present; whether components of the underbody present; whether components of the underbody missing; or whether components of the underbody modified. In particular, the output may comprise modifying the concatenated image(s) to highlight rust and to request the inspector to confirm or reject the contention that rust is present in the underbody. Various types of modifications are contemplated, such as superimposing an overlay (e.g., a box, a circle, or the like) and/or changing pixel values within the concatenated image to highlight (e.g., changing pixels to bright red to highlight the rust). Alternatively, or in addition to the modified concatenated image(s), text may be output on the screen to indicate the conclusion (e.g., output “Rust Detected; please confirm”; output “No catalytic converter detected; please confirm”; or output: “Exhaust system modification detected; please confirm”). The input from the inspector may thus be the confirmation or rejection of the contention.

Responsive to the input from the inspector, at 328, the inspection report may be generated. In one or some embodiments, the mobile device (e.g., the smartphone) may generate the inspection report. Alternatively, or in addition, the server may generate the inspection report.

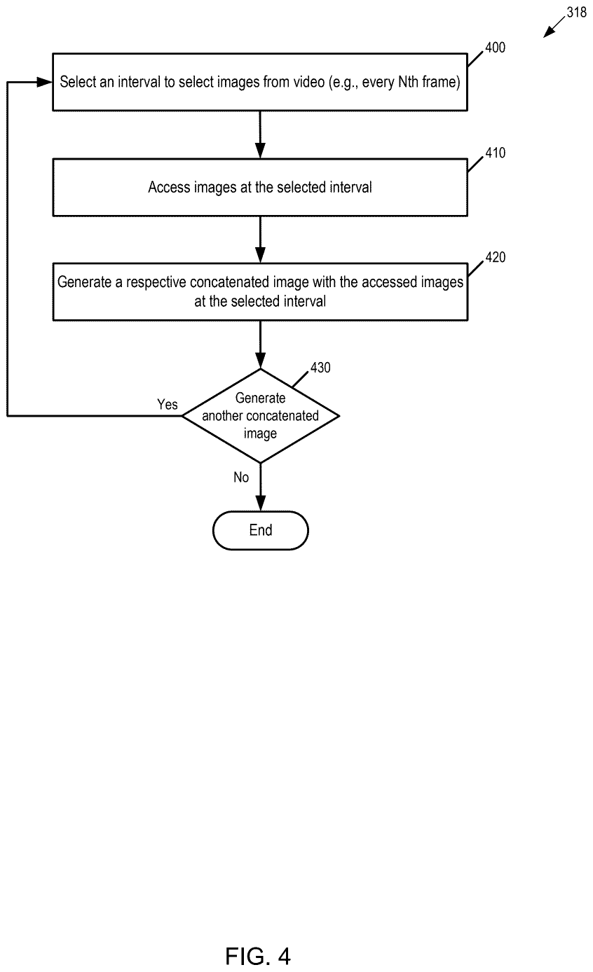

FIG. 4 illustrates an exemplary flow diagram of logic to generate concatenated image(s) 318. As discussed above, there are various ways in which to generate concatenated image(s) 318. One example is to generate multiple concatenated image(s) based on frame rate. To that end, at 400, the system may select an interval from which to select images of video (e.g., every Nth frame). At 410, the images from the video may be selected at the selected or designated interval. As discussed above, the images from the video may have one or more predicate steps performed, such as removing pixels and/or de-skewing. At 420, a respective concatenated image may be generated with the accessed images at the selected interval. At 430, it is determined whether to generate another concatenated image. If so, the flow diagram in FIG. 4 loops back to 400. If not, the flow diagram ends.

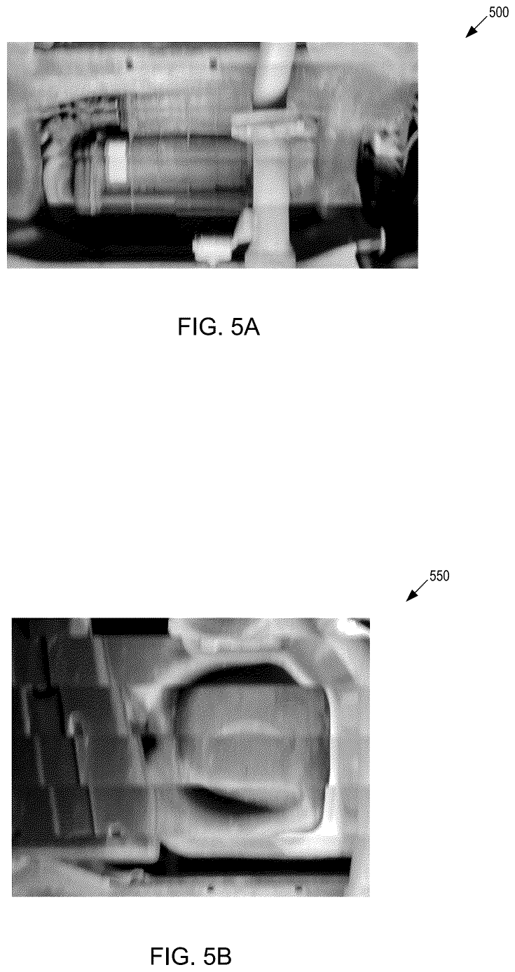

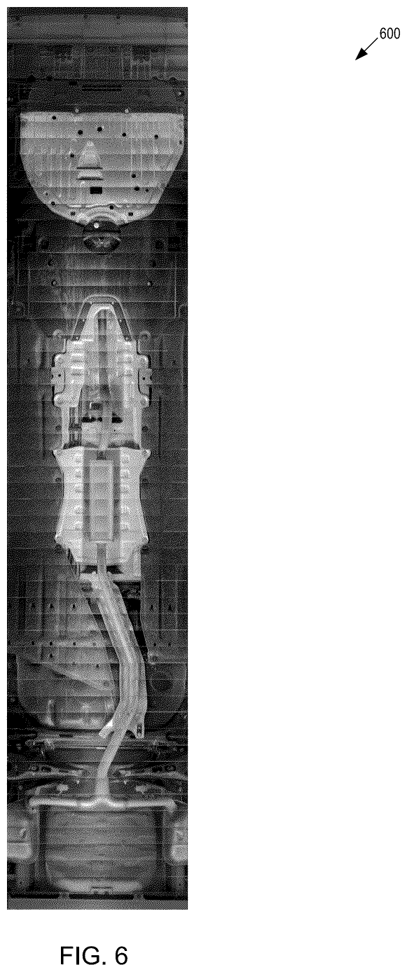

FIGS. 5A-B illustrates example concatenated images 500, 550. FIG. 6 illustrates an example of a post-processed concatenated image 600, in which one or more post-processing actions are performed on the concatenated image.

FIG. 7 is an example of a mirror structure 700 and a mobile device 750. As shown in FIG. 7, the mirror structure 700 includes a mirror 710 that has one or more sides, such as sides 720, 722, 724, 726. A frame 740 may frame one, some, or each of the one or more sides, such as each of sides 720, 722, 724, 726, as shown in FIG. 7. The frame 740 may have a distinct color, such as a predetermined values for R, G, B (e.g., a neon green color) and/or distinct shape(s) (e.g., a rectangular shape of similar or same valued pixels, such as illustrated in FIG. 7, a trapezoidal shape of similar or same valued pixels, etc.). As discussed herein, the distinct color and/or distinct shape may be used to identify the frame 740, and to crop pixels within and/or outside of frame 740. Further, mirror structure 700 may include a stand 730 or the like to position the mirror 710 at a predetermined angle. The mobile device 750 may be place proximate to, but not in fixed relation to, the mirror structure 700.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

What is claimed is:

1. A method for generating at least one concatenated image of a vehicle underbody, the method comprising:
generating, using at least one mobile device, a plurality of images of the vehicle underbody;
generating, using at least a part of the plurality of images, the at least one concatenated image independent of any analysis amongst the plurality of images;
after generating the at least one concatenated image, performing at least one post-processing action on the concatenated image to generate at least one post-processed concatenated image; and
outputting the at least one post-processed concatenated image.

2. The method of claim 1, wherein generating the at least one concatenated image is independent of any analysis across the plurality of images in order to determine one or both of commonalities or differences across the plurality of images.

3. The method of claim 1, further comprising performing one or more predicate steps prior to generating the at least one concatenated image, the one or more predicate steps comprising one or both of:
removing or modifying one or more portions of the plurality of images; or
de-skewing the at least a part of the plurality of images.

4. The method of claim 3, wherein the at least mobile device generates the plurality of images in conjunction with at least one mirror, the at least one mirror having a frame on one or more sides of the at least one mirror; and
wherein removing or modifying the one or more portions of the concatenated image that are external to the vehicle underbody comprises:
determining, based on at least one predetermined pixel value, the frame in the plurality of images; and
removing, from the plurality of images, at least the frame and outward from the frame.

5. The method of claim 1, further comprising placing at least one mirror and the at least one mobile device on a ground without any structure between the at least one mirror and the at least one mobile device to impose a fixed relation between the at least one mirror and the at least one mobile device;
wherein generating the plurality of images comprises:
after placing the at least one mirror and the at least one mobile device on the ground, activating the at least one mobile device to take a video; and
after activating the at least one mobile device to take the video, driving a vehicle over one or both of the at least one mirror or the at least one mobile device; and
further comprising de-skewing the at least a part of the plurality of images.

6. The method of claim 5, wherein de-skewing the at least a part of the plurality of images comprising:
determining, based on at least one superimposed line on at least one image generated by the mobile device, an amount of skew of the at least one image; and
rotating, based on the amount of skew, the at least a part of the plurality of images in order to de-skew the at least a part of the plurality of images.

7. The method of claim 1, wherein the at least one mobile device generates the plurality of images as part of a video; and
wherein generating the at least one concatenated image comprises:
selecting different frames of the video that are a predetermined number of frames spaced apart from one another; and
generating the at least one concatenated image by combining the different frames that are the predetermined number of frames spaced apart from one another.

8. The method of claim 7, wherein a plurality of the concatenated images are generated using a same video;
wherein the plurality of concatenated images are post-processed in order to generate a plurality of post-processed concatenated images; and
further comprising:
outputting the plurality of the post-processed concatenated images on a display of the at least one mobile device in order to solicit an inspector for a selection of one of the plurality of the post-processed concatenated images; and
receiving from the inspector the selection of the one of the plurality of the post-processed concatenated images.

9. The method of claim 8, wherein at least a first concatenated image and a second concatenated image are generated from the same video;
wherein the first concatenated image is generated by:
selecting a first set of frames of the video that are a first predetermined number of frames spaced apart from one another; and
generating the first concatenated image by combining the first set of frames that are the first predetermined number of frames spaced apart from one another; and
wherein the second concatenated image is generated by:
selecting a second set of frames of the video that are a second predetermined number of frames spaced apart from one another, wherein the second predetermined number of frames is different from first predetermined number of frames; and
generating the second concatenated image by combining the second set of frames that are the second predetermined number of frames spaced apart from one another.

10. The method of claim 9, wherein performing the at least one post-processing action on the first concatenated image and the second concatenated image generates a post-processed first concatenated image and a post-processed second concatenated image;
wherein the post-processed first concatenated image and the post-processed second concatenated image are output simultaneously on a display of the at least one mobile device for an inspector to view; and
further comprising receiving input from the inspector of a selection of one of the post-processed first concatenated image and the post-processed second concatenated image.

11. The method of claim 10, wherein the at least one post-processing action comprises smoothing;
wherein the first concatenated image is composed of a plurality of underlying images; and
wherein the smoothing comprises averaging values of pixels from the plurality of underlying images abut one another in the first concatenated image.

12. The method of claim 10, wherein the at least one post-processing action comprises analyzing at least a part of the first concatenated image and at least a part of the second concatenated image in order to identify one or more problems in the vehicle underbody;
further comprising modifying the first concatenated image and the second concatenated image in order to highlight the one or more problems identified in the vehicle underbody;
wherein the input received from the inspector further includes an indication of agreement or disagreement of the one or more problems identified in the vehicle underbody.

13. The method of claim 12, wherein the one or more problems identified comprise one or more of: rust; lack of a catalytic converter; or detection of exhaust system modification.

14. At least one mobile device configured for inspection of a vehicle underbody, the at least one mobile device comprising:
at least one camera configured to generate a plurality of images of the vehicle underbody;
at least one input device;
at least one output device; and
at least one processor in communication with the at least one camera, the at least input device, and the at least one output device, the at least one processor configured to:
access at least one post-processed concatenated image that was generated by: generating at least one concatenated image using at least a part of the plurality of images of the vehicle underbody and generated independently of any analysis amongst the plurality of images; and post-processing the at least one concatenated image of the vehicle underbody;
output, on the at least one output device for an inspector, the at least one post-processed concatenated image of the vehicle underbody; and
receive, from the inspector via the at least one input device, input regarding the at least one post-processed concatenated image of the vehicle underbody.

15. The at least one mobile device of claim 14, wherein the at least one input device and the at least one output device comprise a touchscreen;
wherein the at least one processor is configured to simultaneously output on the touchscreen a plurality of different post-processed concatenated images of the vehicle underbody; and
wherein the at least one processor is configured to receive the input from the inspector indicative of a selection of at least one of plurality of different post-processed concatenated images of the vehicle underbody for inclusion in an inspection report of a vehicle that includes the vehicle underbody.

16. The at least one mobile device of claim 15, wherein the at least one camera is configured to generate a video that includes the plurality of images of the vehicle underbody;
wherein the at least one processor is configured to generate, from the video, a first concatenated image by:
selecting a first set of frames of the video that are a first predetermined number of frames spaced apart from one another; and
generating the first concatenated image by combining the first set of frames that are the first predetermined number of frames spaced apart from one another; and
wherein the at least one processor is configured to generate, from the video, a second concatenated image by:
selecting a second set of frames of the video that are a second predetermined number of frames spaced apart from one another, wherein the second predetermined number of frames is different from first predetermined number of frames; and
generating the second concatenated image by combining the second set of frames that are the second predetermined number of frames spaced apart from one another;
wherein the at least one processor is configured to perform the post-processing on the first concatenated image to generate a post-processed first concatenated image and to perform the post-processing on the second concatenated image to generate a post-processed second concatenated image; and
wherein the at least one processor is configured to simultaneously output on the touchscreen the post-processed first concatenated image and the post-processed second concatenated image of the vehicle underbody.

17. The at least one mobile device of claim 16, wherein the at least one processor is configured to perform the post-processing by analyzing the first concatenated image and the second concatenated image in order to identify one or more problems in the vehicle underbody; and
wherein the at least one processor is configured to generate the post-processed first concatenated image and the post-processed second concatenated image in order to highlight the one or more problems identified in the vehicle underbody.

18. The at least one mobile device of claim 17, wherein the one or more problems identified comprise one or more of: rust; lack of a catalytic converter; or detection of exhaust system modification.

19. The at least one mobile device of claim 17, wherein the at least one processor is configured to generate the post-processed first concatenated image and the post-processed second concatenated image by superimposing at least one overlay on the first concatenated image and on the second concatenated image, respectively, in order to highlight the one or more problems identified in the vehicle underbody.

20. The at least one mobile device of claim 14, wherein the at least one mobile device is configured to be placed on a ground relative to at least one mirror without any fixed relation therebetween in order to obtain the plurality of images of the vehicle underbody reflected via the at least one mirror; and
wherein the at least one processor is further configured, prior to generating the at least one concatenated image, to:
determine skewing of the plurality of images; and
at least partly de-skew, based on the determined skewing, the plurality of images in preparation for generating the at least one concatenated image.
